(19) United States
(12) Patent Application Publication
(10) Pub. No.: US 2007/0050217 A1
(43) Pub. Date: Mar. 1, 2007

(54) Method for forming a multi-peril insurance policy

(76) Inventor: Ellsworth J. Holden JR., Athens, OH (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 11/212,335

(22) Filed: Aug. 26, 2005

(51) Int. Cl. G06Q 40/00

(52) U.S. Cl. 705/4

(57) ABSTRACT

A method that combines into one insurance policy, perils which tend to offset each other, the offsetting being manifested by negative correlations in the payouts of benefits for the offsetting pair or pairs of risks. The method includes, selecting a population of potential policyholders to be insured and dividing the population of potential policyholders into several subpopulations; the probability distributions of which are estimated for payments of benefits to policyholders in a particular subpopulation. Followed by estimating a plurality of statistical properties of benefit payouts for at least two perils. Furthermore, specifying at least one statistical property based upon its relation to an acceptable risk level. Finally, creating at least one combined policy that meets the specified statistical property and pays out benefits in the event that at least one of the perils occurs.

### BACKGROUND OF THE INVENTION

1. Field of the Invention

This invention relates generally to a method for forming an insurance policy and more specifically a method for forming a multi-peril insurance policy.

2. Description of the Related Art

In the past, it has been difficult for an insurance provider to prepare a comprehensive plan for an individual that is not too risky for the insurance provider to cover and yet not too expensive for the individual. Typically, an individual who wishes to purchase life insurance, an annuity and long term care (LTC) insurance can purchase these forms of protection separately. However, the high premiums for these policies often limit the individual to only being able to purchase inadequate coverage.

There is a high degree of uncertainty in setting premiums for private long-term care insurance, which leads to high premiums in order to provide a safety factor for the insurer. Uncertainty also leads to premiums that are not guaranteed for the life of the contract, but which may be increased as time passes; that is, these premiums are not “noncancellable”, but only “guaranteed renewable”. Policyholders often drop their coverage because of steep premium increases and then are left with no LTC insurance when they need it. In addition, the pricing of LTC insurance is difficult for several reasons. Among those are estimating the use of nursing home services and home-health-care services, the future costs of these services, along with adverse selection.

The LTC policies on the market are apparently not very attractive to many individuals. It has been found that only 2.2% of the elderly and 1.6% of the near elderly have private LTC insurance coverage. In addition, many people do not annuitize annuities; only about 2% of annuities are ever annuitized. So the key feature (and basis for the product's name) is seldom utilized. This is despite the need for reliable retirement income to replace the pension check of prior generations.

Each of these three types of insurance, as sold in stand-alone policies, is subject to substantial adverse selection, when compared with the general population. Therefore, it is the object and feature of the invention to provide a method for forming a multi-peril combined insurance policy.

### BRIEF SUMMARY OF THE INVENTION

The invention is a method that combines into one insurance policy, perils which tend to offset each other. The offsetting is manifested by negative correlations in the payouts of benefits for the offsetting pair or pairs of risks.

The method includes, selecting a population of potential policyholders to be insured and dividing the population of potential policyholders into several subpopulations. Next, the probability distributions for payments of benefits to policyholders in a particular subpopulation are estimated. A plurality of statistical properties of benefit payouts are estimated for at least two perils and at least one statistical property is specified based upon its relation to an acceptable risk level. Finally, a combined policy is created that meets the specified statistical property and pays out benefits in the event that one or more perils occur.

The method is used to create a multi-peril insurance policy preferably combining long term care (LTC) insurance, life insurance and an annuity as the perils. This method is advantageous over stand-alone policies because the correlation coefficient for payouts of benefits for life insurance and an annuitized annuity is, in principle, negative one (−1). Whatever the correlation coefficients between LTC and both life insurance and an annuitized annuity, whether they are positive or negative, a combined policy can be designed to meet a specified statistical property such as the coefficient of variation property. For all of the models formulated, the correlation coefficient between LTC and an annuitized annuity is a moderate-sized positive number, and the correlation coefficient between LTC and life insurance is a moderately larger negative number. By using the preferred method, an insurer can sell the combined policy for a smaller premium than each of the policies separately because there is need for a smaller “cushion” against variability in payouts of benefits, and because using the same mortality table for all of the perils in the policy reduces the expected payout, compared with using a separate mortality table for each peril.

### BRIEF DESCRIPTION OF THE SEVERAL VIEWS OF THE DRAWINGS

FIG. 1 is a table illustrating the preferred method of the present invention.

FIG. 2 is a table illustrating the embodiment of FIG. 1 with inflation protection.

FIG. 3 is a table illustrating a prior art embodiment.

FIG. 4 is a table illustrating a prior art embodiment with inflation protection.

FIG. 5 is a table illustrating a comparison between the embodiment of FIG. 1 and the embodiment of FIG. 3.

FIG. 6 is a table illustrating a comparison between the embodiment of FIG. 2 and the embodiment of FIG. 4.

In describing the preferred embodiment of the invention, which is illustrated in the drawings, specific terminology will be resorted to for the sake of clarity. However, it is not intended that the invention is limited to the specific term so selected and it is to be understood that each specific term includes all technical equivalents, which operate in a similar manner to accomplish a similar purpose.

### DETAILED DESCRIPTION OF THE INVENTION

Insurers operate within a risk-based-capital environment. However, by utilizing the preferred method to formulate a combined policy so that the combined policy has the same risk (coefficient of variation) as an annuitized annuity, the insurer can substitute a combined policy that protects against multiple perils for an annuitized annuity with no impact upon its actual risk profile.

A Brief Example of the Preferred Method.

To begin an insurer selects the perils that will be incorporated into the multi-peril policy. In this example the perils selected include long-term care insurance (LTC), an annuitized annuity, and life insurance. These three perils are selected because at least two of the perils are somewhat negatively correlated. Negative correlation between two quantities means that large values of one of the quantities tend to be associated with small values of the other quantity, and vice versa. For example, an annuitized annuity and a life insurance policy have a negative correlation with each other because an annuitized annuity, by definition, is paid during a lifetime of an individual, while a life insurance policy is only paid after the insured has died.

The insurer must select the population to be insured and divide the population of potential policyholders into several subpopulations or risk classes such that the members of each sub-population can be treated as reasonably homogeneous.

For each subpopulation, the insurer will obtain or estimate, using both a mortality table and a morbidity table for the members of the subpopulation, probability distributions for the payments of benefits to policyholders in that subpopulation. The insurer then estimates the statistical properties of the benefit payouts for the three selected perils.

Next, the insurer specifies one statistical property, based upon its relation to an acceptable risk level, which the combined policy will be designed to meet. Initially, this statistical property will preferably be that the coefficient of variation of the payouts for the combined policy equals the coefficient of variation for the annuitized annuity. The reason the annuitized annuity is preferably selected is because an annuitized annuity is a low-risk policy for an insurer to write. However, other properties could be chosen. The coefficient of variation is the standard deviation of the benefit payouts divided by the expected value of the benefit payouts.

The insurer creates at least one, but preferably a variety of combined policies that meet the specified statistical property that pays out benefits for any of the perils that occur. The benefit levels for the three risks to be insured must be chosen, and some sample benefit levels are illustrated in FIG. 1 columns C, D, and E. This step will specify the multi-peril policy. The creating of the combined policy proceeds by selecting a benefit level for LTC, such as $2000 per month and then selecting a series of possible values for the annuitized-annuity benefit level, such as $200 per month, $300 per month, $500, $700, $1000, $1500, $2000, $2500 or $3000 per month.

For each of the pairs of benefit levels selected, the insurer calculates the life-insurance face amount that will make the combined policy fulfill the specified condition on the coefficient of variation.

This process can then be repeated for several values of the LTC benefit level, such as $3000 per month, $4000 per month, $5000 per month, et cetera. Since all benefit levels can be doubled, tripled or multiplied by any other positive real number without changing the specified statistical property of the combined policy, this last step can be done very easily.

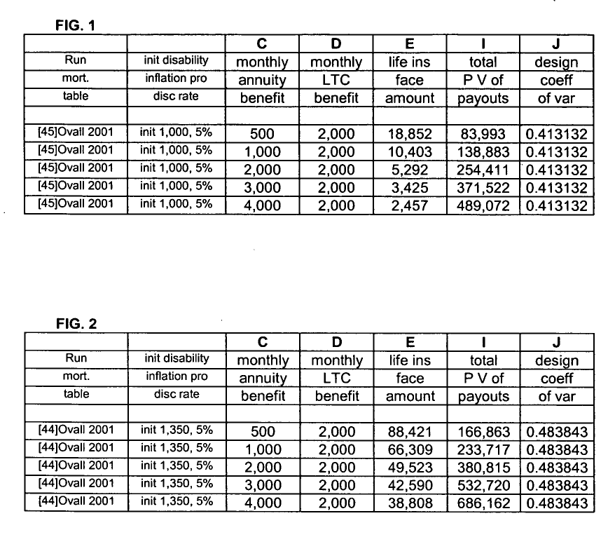

Following is a schedule showing, in each row, the benefit levels for a variety of possible of combined policies, as illustrated in FIG. 1, all of which have the same risk structure as a pure annuitized annuity. See FIG. 2, columns C, D, and E for a combined policy with inflation protection built in to the policy.

| Annuitized | LTC | Life |
|---|---|---|
| Annuity | Benefit | Insurance |
| $200 | $2,000 | $36,617 |
| 300 | 2,000 | 28,090 |
| 500 | 2,000 | 18,979 |
| 700 | 2,000 | 14,176 |
| 1,000 | 2,000 | 10,113 |
| 1,500 | 2,000 | 6,628 |
| 2,000 | 2,000 | 4,764 |
| 2,500 | 2,000 | 3,605 |
| 3,000 | 2,000 | 2,813 |

The relative levels of the benefit payouts are then fixed at the chosen (by the insured) levels, such as $2000 LTC benefit, $3,000 annuitized annuity and $2,813 face amount of life insurance for the life of the policy. This avoids adverse selection by the policyholder during the life of the policy. For example, suppose a policyholder sees his/her doctor who says, “You are very healthy. You will ‘live forever’.” The policyholder may be inclined to go to the insurance agent and say “Switch everything to an annuity-no more life insurance.” However, suppose instead the doctor said, “You are full of cancer. You won't live four months.” The policyholder now would like to change everything to life insurance, because an annuity, which pays until death, will not be very valuable. This fixing of values at the time at which the policy is issued just affects the situation AFTER the policy has been issued.

How the Method Works:

The preferred method uses a Monte Carlo simulation program to attain the results illustrated in FIG. 1. Beginning with simulated age 65, the method is repeated year after year until the probable death of the simulated individual. Benefit payments for each peril for each year are calculated and, at the simulated death, the present values of the annual payouts are discounted back to age 65 and summed. Many simulations can be run for various circumstances and summary statistics are then calculated for each group of simulated individuals.

In order to obtain the results shown in FIG. 1, morbidity and mortality tables are selected and incorporated into the simulation. Morbidity tables for a simulated individual to enter a nursing home in a particular year and for that individual's length of stay can be adapted from Tables 19 and 20 of the “Brookings/ICF Long Term Care Financing Model: Model Assumptions” (U.S. Department of Health and Human Services, February, 1992). At least one mortality table is chosen to simulate the overall probability of an individual's death in that year. For example, one of the following mortality tables can be chosen:
“In Sickness and in Health: An Annuity Approach to Financing Long-Term Care and Retirement Income” by Murtaugh, Spillman and Warshawsky, The Journal of Risk and Insurance, 2001
2001 [insurance] Commissioners Standard Ordinary mortality table
1980 [insurance] Commissioners Standard Ordinary mortality table
The annuity mortality table and the overall population mortality table from Table 1.1, in the book, “The role of Annuity Markets in Financing Retirement” by Brown, Mitchell, Poterba and Warshawsky, The MIT Press, 2001 (referred to below as Reference A).
   However, a person having ordinary skill in the art will recognize that these are only examples of morbidity and mortality tables and any variety of published tables can be used.

When designing a multi-peril policy that includes an annuitized annuity, long-term-care insurance and life insurance, the preferred statistics calculated include:
the sample average to estimate the expected payout for the three perils and age at death;
the standard deviation for each of these four quantities;
the correlation coefficient between each of the three pairs (Annuity-LTC), (LTC-Life Ins) and (Annuity-Life Ins).
   However, as will be recognized by a person having ordinary skill in the art, other summary statistics can be calculated.

Several dozen simulation runs, each simulation run being comprised of several thousand simulated lives, can be made based upon the following considerations. Each simulated person's health in accordance with the Brookings/ICF model is classified as:
1 no disability
2 unable to perform at least one “instrumental activity of daily living”, such as, doing heavy work or doing light work, preparing meals, shopping for groceries, walking outside, managing money
3 unable to perform one of the “activities of daily living”, such as, eating bathing, dressing, toileting, getting in and out of bed
4 unable to perform two or more of the “activities of daily living”
   Each simulated year there is a probability that an individual will change from the current state of disability to another state of disability. It is assumed that at age 65 an individual is properly classified into one of these four categories.

Simulations can be performed with no “inflation protection” for the benefit levels, as illustrated in FIG. 1. That is, benefit levels do not change from year to year. Alternatively, simulations can be performed with annuity payments increasing 3 percent each year, LTC payments increasing 5 percent each year and with no change in the face amount of the life insurance, as illustrated in FIG. 2. As a person having ordinary skill in the art will recognize, many other inflation-protection patterns can be utilized, but the one chosen is a typical pattern.

In all cases the general pattern is the same. For a chosen LTC benefit level, one can set an annuity benefit level and find the corresponding amount of life insurance required to meet the specified value for the coefficient of variation of the combined policy. The larger the annuity benefit, the smaller the face amount of life insurance required, and vice versa. For each specific combined policy (that is, for each set of values of the LTC benefit and annuity benefit) the smaller the imposed design value of the coefficient of variation or the smaller the specified amount of risk, the larger the face amount of life insurance required, and vice versa.

The design property used for the combined policy is that the coefficient of variation (CV) of the combined policy equals the CV for the annuity component of the combined policy. In FIG. 1 column J the CV equals 0.413132. There are many other choices that one could make, but this example uses a comparison with which insurers are familiar and comfortable, namely, the risk associated with an annuitized annuity.

Alternatively, if inflation protection is added to the benefits of a policy, this will change the value of the CV for the annuity component. As illustrated in FIG. 2, the CV is thus 0.483843 as shown in the calculations in Column J. Including inflation protection is somewhat more risky. The result would be a greater face amount of life insurance in each row.

There are other possible choices of statistical design parameters for a combined policy. For example, one could specify that a combined policy satisfied a specified risk-return relationship. Furthermore, one could use a statistical property other than a coefficient of variation as the design parameter. For example one could require that the combined policy lie on a specified risk-return line or that it have a specified total expected benefit payout. Alternatively, one could impose two conditions instead of one that the combined policy must meet. For example, a specified value for the coefficient of variation and that the skewness property is equal to or less than a specified value. Other properties, which can be used, are the 95^{th} percentile benefit payout, the average of the largest ten percent of payouts and the average of the largest thirty-five percent of payouts.

All of the cases mentioned above represent instances in which there are three components in the combined policy. More complex applications could involve four or more perils, which would lead to choosing four or more benefit levels in designing a combined policy. It is also noted that the method can be applied to a case in which there are just two perils.

Terminology and inputs to the calculation of the benefit levels for the combined policy include:

| | | | |
|---|---|---|---|
| Subscript | 1 | refers to the | (annuitized) annuity |
| | 2 | refers to the | LTC insurance |
| | 3 | refers to the | life insurance. |

E denotes estimate of the expected value of a benefit payout
S denotes standard deviation of a stream of benefit payouts
R denotes correlation coefficient between two of the benefit payout streams
   Thus, for example,
E₁ denotes estimate of expected payout for the annuity component
S₂ denotes standard deviation for the LTC component
R₂₃ denotes correlation coefficient between the LTC and life insurance payouts

For example assume that calculations have been made for the benefit levels of:

$1,000 per month for the annuity

$2,000 per month for the LTC benefit and

$100,000 for the face amount of life insurance.

To form a specific combined policy, an insurer introduces factors A, B, and C, respectively, which multiply the three benefit levels just described. Thus,

| | | | | |
|---|---|---|---|---|
| A | equal to | 0.5 | corresponds to | an annuity of 0.5 times $1,000 or |
| | | | | an annuity of $500 per month |
| B | equal to | 1 | corresponds to | an LTC benefit of $2,000 per month |
| C | equal to | 0.4 | corresponds to | a life insurance face amount of |
| | | | | $40,000. |

A specific policy is designed by choosing the values of A, B, and C. The expected payout for a combined policy denoted by A, B and C is
E=A E₁+B E₂+C E₃.
The variance (square of the standard deviation) for the combined policy will be

$$Var = {A}^{2} {S}_{1}^{2} + {B}^{2} {S}_{2}^{2} + {C}^{2} {S}_{3}^{2} + 2 AB {S}_{1} {S}_{2} {R}_{12} + 2 {BCS}_{2} {S}_{3} {R}_{23} + 2 {ACS}_{1} {S}_{3} {R}_{13}$$

The coefficient of variation for the combined policy, CV, equals the square root of Var (above) divided by E.

The design parameter for this example will be that the coefficient of variation for the combined policy will equal the coefficient of variation for the annuity component of the combined policy; the latter will be denoted as CV₁:
CV₁ equals A S₁ dividedby A E₁ or S₁/E₁

The design condition will be that CV equals CV₁. For convenience and to avoid square roots, square both sides. Thus, from above, the equation that embodies the design condition is:

$$\frac{[ \begin{matrix}{A}^{2} {S}_{1}^{2} + {B}^{2} {S}_{2}^{2} + {C}^{2} {S}_{3}^{2} + \\ 2 AB {S}_{1} {S}_{2} {R}_{12} + 2 {BCS}_{2} {S}_{3} {R}_{23} + 2 {ACS}_{1} {S}_{3} {R}_{13}\end{matrix} ]}{{[ {AE}_{1} + {BE}_{2} + {CE}_{3} ]}^{2}}$$

$${equals \\ [ {S}_{1} / {E}_{1} ]}^{2}$$

All of the E's, S's and R's are known quantities from the results of a simulation run.

There is thus one equation relating A, B and C. First, to set the scale for the combined policy, set B=1. Note that if A, B and C are all doubled, the equation is unchanged. There is now one equation in A and C. If a value is assigned to A, then a quadratic equation is formed in the one unknown C, which specifies the face amount of life insurance that is required for the designated values of A and B. A quadratic equation has two roots, which may be real or complex. A real solution may be positive or negative. Of course, it is only positive, real values of C, which yield useful results.

One key to the success of the method in producing a multi-peril policy with specified statistical properties is fixing the benefit levels for the various components when the policy is issued and keeping them fixed throughout the life of the policy. The purpose of fixing the benefit levels at the time at which the policy is issued is to avoid adverse selection by the policyholder during the life of the policy. A combined policy is designed to meet certain specified statistical properties over the life of the insurance contract and part of meeting these specified properties is keeping the benefit levels unchanged.

Comparison to Known Methods:

Considering three stand-alone policies, the risk-based-capital requirements for the annuity and life insurance policies are small percentages of the premiums, but the risk-based-capital requirement for a stand-alone LTC policy will be a much larger percentage of the premium than for annuity and life insurance policies. However, it seems reasonable to apply that same low risk-based-capital requirement to the entire premium of the combined policy if that combined policy has been designed to have a coefficient of variation as small as or even smaller than the coefficient of variation of a stand-alone annuity. Thus, a significantly smaller amount of capital should be required to be retained by the writing insurer to support a combined policy than to support three stand-alone policies with the same benefit levels.

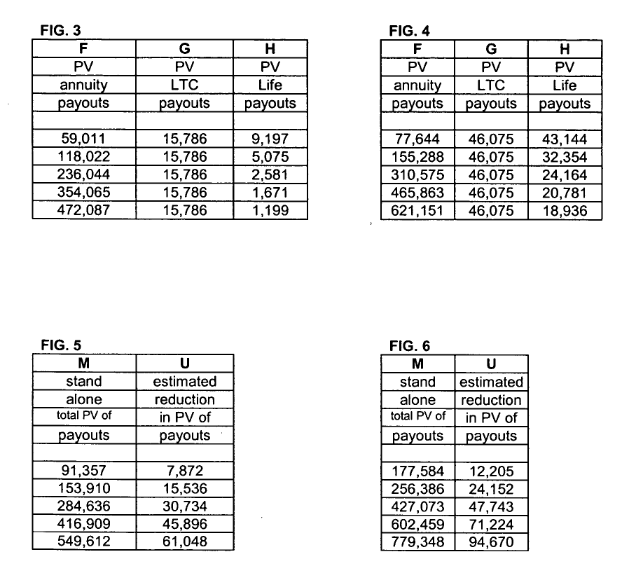

The combined policy can be compared to previous methods of preparing stand-alone policies both with and without inflation protection. FIGS. 3 and 4 are tables illustrating the results of calculations using a known method for preparing stand-alone policies. The total present value of payouts is shown in column M in both FIGS. 5 and 6. This number is analogous to column I in FIGS. 1 and 2 for the combined policy. Column U shown in FIGS. 5 and 6 illustrates the difference in policy payouts for the insurer when using the preferred method for preparing a combined policy versus preparing a stand-alone policy using a prior known method. The differences are very beneficial to an insurer when using the preferred method. There are two components to the reduction in expected payouts First, for the combined policy the same mortality table is used for all of the perils, rather that an annuity mortality table for the annuity portion of the combined policy and a life insurance mortality table for the life insurance component. Secondly, the reduced risk regarding the LTC insurance peril, especially, leads to a proposed reduction in risk based capitol (RBC) for a combined policy. This proposed reduction in RBC times the insurer's cost of capital yields an estimate for the insurer's saving in the cost of RBC.

Additional Comparison

The following demonstrates that combined policies can be designed that are less risky than both annuitized annuities and life insurance when following the preferred method. The statistic used for comparison is the 95^{th} percentile benefit payout.

The coefficient of variation (CV) is used to design combined policies and to compare them with annuitized annuities and life insurance policies. As noted elsewhere, various other design properties can be chosen for designing combined policies. These alternatives include, but certainly are not limited to, the average of the ten percent largest in the distribution of payouts and a benefit-payout quantity which is “at least as much as is needed in 95 percent of the trials” in simulation runs. These statistics are rather similar in behavior. The risk-based capital requirements for life insurance in the 2004 National Association of Insurance Commissioners (NAIC) publication seem to be based upon this “95 percent of the trials” statistic. This 95-percent-of-the-trials statistic, which is virtually identical with the 95^{th} percentile benefit payout, is used to make comparisons of combined policies with annuitized annuities and with life insurance policies.

The following analyses are based upon simulation runs only for the following two situations:
Mortality table: overall population, 2001, reference A
Single-premium policies issued at age 65
Initial state of disability: no disability
Risk-free discount rate: 5 percent
Males only

Inflation protection:

| | |
|---|---|
| Situation one Run [A] | 3% for the annuitized annuity. |
| | 5% for the long-term care benefits |
| | 0% for the face amount of the life insurance. |
| Situation two Run [B] | no inflation protection |

The combined policies are designed to meet specified values of the coefficient of variation. The smaller the coefficient of variation, the less risky the corresponding combined policy. Each combined policy is compared with an annuitized annuity and a life insurance policy, each of whose benefit levels are adjusted so that the expected payouts of benefits are the same for all three policies in a particular comparison.

For a particular comparison, the 12,000 simulated payouts for the pure annuitized annuity are sorted and the 601^{st} largest payout is selected (because 600 is five percent of 12,000). Next, the payouts for the corresponding combined policy are sorted and the 601^{st} largest payout is selected. Finally, the payouts for the pure life insurance policy are sorted and the 601^{st} largest payout is selected.

Table I, below, illustrates the level of risk of combined policy, compared with annuitized annuity and with life insurance, as measured by what is essentially the amount of the 95th percentile benefit payout. The table is only a brief summary of the results of the calculations.

TABLE I

| | | | | riskiness of comb. policy | | |
|---|---|---|---|---|---|---|
| | | | | compared with | | |
| inflation | monthly | LTC | | coefficient | annuitized | life |
| protection* | annuity | benefit | life insurance | of variation** | annuity | insurance |
| 350 | $3,000 | $2,000 | $42,590 | 0.4838 | greater | greater |
| 350 | 3,000 | 2,000 | 99,476 | 0.44 | greater | smaller |
| 350 | 3,000 | 2,000 | 137,413 | 0.4131 | smaller | smaller |
| 350 | 3,000 | 2,000 | 156,898 | 0.4 | smaller | smaller |
| 350 | 3,000 | 2,000 | 220,498 | 0.36 | smaller | smaller |
| 350 | 3,000 | 2,000 | 291,384 | 0.32 | smaller | smaller |

*350 inflation protection means a 3% annual increase in the annuity payments, a 5% annual increase in LTC benefits and no increase in life insurance benefits.
**0.4838 is the coefficient of variation for the annuitized annuity under the conditions of this simulation run with 350 inflation protection and 0.4131 is the coefficient of variation for a simulation run under the same circumstances but with no inflation protection.

In each case, a combined policy becomes less risky as the coefficient of variation to which it is designed is reduced. The topmost entries are for a $3000 monthly-annuitized annuity benefit, which is relevant for estate planning in the context of choosing a monthly income level and then choosing for the LTC benefit level the incremental amount of income, which is desired if LTC benefits are needed. This display includes inflation protection, as described.

In comparison, the second group, which is for a $1000 per month annuitized annuity benefit, requires a smaller coefficient of variation before the combined policy becomes smaller in risk than the two stand-alone comparison policies.

The value 0.4838 is the coefficient of variation for the annuitized annuity with the specified inflation protection and 0.4131 is the corresponding coefficient of variation for the annuitized annuity without inflation protection. The bottom two displays show similar results for the cases without inflation protection.

Alternative Uses for the Preferred Method

There are many alternative uses for the preferred method. For example, employee benefits or individual or group insurance coverage can be calculated using the preferred method, such as combining:
routine health care and/or preventive health care
major medical insurance
disability income insurance
life insurance

Preventive health care and routine health care are low enough in variability to act similarly to an annuity when part of a combined policy. Major medical insurance and/or disability income insurance (for people under fifty years of age) will be analogous to LTC insurance. Life insurance will play its usual role of being negatively correlated with routine health care and/or preventive health care.

Medical spending accounts (medical savings accounts) plus high-deductible major medical insurance are used more frequently today. Adding life insurance to this combination would enable the design of a combined package, which meets a specified coefficient of variation.

In addition, financial planning for parents with disabled children can be calculated using the preferred method. For example, suppose a parent chose to purchase an annuitized annuity today of X dollars a month for the life of the parent and purchased for the dependent child an annuity of Y dollars per month that would begin upon the death of the parent and continue until the death of the child. There will be a strong negative correlation in the amounts of money, which the insurer will be called upon to pay out in benefits for these two annuities. The longer the parents' lives, the shorter and further in the future will be the payments to the child, and, vice versa.

Thus, there is a basis for designing a combined policy to meet a specified coefficient of variation even before bringing in consideration of insurance for perils such as LTC insurance, major medical insurance and life insurance for both or either of parent and child. However, there are special considerations involved in this area, and they go well above and beyond simply designing an appropriate combined policy.

Finally the approach of the combined policy will be very useful for estate planning. Broadly speaking, a person doing estate planning will have assets such as 401K accounts, 403Bs, defined-benefit pensions, mutual funds, portfolios of stocks and bonds, et cetera. The essential challenge is to use the assets at a rate which will provide a comfortable style of living without exhausting the assets before death and enabling the retiree to meet health-care needs and long-term-care needs as they arise, as well as providing monthly income. A second desire of retirees is to have a “nest egg” to give to the next generation. Those planning estates can then choose how to divide their assets between a combined policy and leaving those assets invested elsewhere.

Expressed in terms of planning for one person, a suitable first step will be to choose the benefit level for the annuitized annuity, probably with inflation protection such as a three percent increase in the benefit level year.

Next, the planner can choose the incremental level of monthly LTC benefit needed if and when the person enters a nursing home or needs home health care. Note that this LTC benefit level does not need to be the total cost of nursing home care because the monthly annuitized-annuity benefit will continue. Again, one would probably choose inflation protection, such as a five percent increase in benefit each year. The insurance underwriter will then calculate the face amount of life insurance required to meet the statistical property or properties for which the combined policy is to be designed.

This method is advantageous over stand-alone policies because the correlation coefficient for payouts of benefits for life insurance and an annuitized annuity is, in principle, negative one. In addition, by using the same mortality and morbidity tables for pricing all of the risks in the combined policy, the combined policy will yield total expected benefit payouts that are less than the sum of the expected payouts for the corresponding stand-alone policies for the same group of risks. For example, for the mortality and morbidity tables used here a pure annuitized annuity of $1,134 per month has the same expected benefit payout and the same standard deviation of payouts as the combined policy with a $1,000 per month annuity, a $2,000 per month LTC benefit and a $6,556 life insurance policy. The skewness and the kurtosis of the payouts are reasonably similar. Thus, one would anticipate that an insurer would be essentially indifferent between writing these two policies. A policyholder could, on the other hand, in effect, “trade” $134 per month of a $1,134 per month annuitized annuity income for the LTC and life insurance coverage. Thus the approach of the combined policy will be very useful for retirement planning.

While certain preferred embodiments of the present invention have been disclosed in detail, it is to be understood that various modifications may be adopted without departing from the spirit of the invention or scope of the following claims.

1. A method for forming a multi-peril insurance policy with pre-specified statistical properties for a selected population of potential policyholders the members of which are treated as substantially homogeneous, and the probability distributions of which are estimated for payments of benefits to policyholders, the method comprising:
(a) estimating a plurality of statistical properties of benefit payouts for at least two negatively correlated perils;
(b) specifying at least one of said statistical properties based upon its relation to an acceptable risk level;
(c) creating at least one insurance policy contract between at least one insurer and at least one insured that meets the specified statistical property and insures against both of said at least two negatively correlated perils by obligating said at least one insurer to pay out benefits to said at least one insured in the event that any of said at least two perils occurs; and
(d) paying, by the insurer, benefits to the insured after any of said at least two perils occurs.

2. The method in accordance with claim 1, wherein said at least two perils further comprises three perils, in which at least two of said three perils are negatively correlated.

3. The method in accordance with claim 1, further comprising fixing the benefit levels for the life of the policy at the time the policy is issued.

4. (canceled)

5. A method for forming a multi-peril insurance policy with pre-specified statistical properties for a selected population of potential policyholders, the members of which are treated as substantially homogeneous, and the probability distributions of which are estimated for payments of benefits to policyholders, the method comprising:
(a) estimating a plurality of statistical properties of benefit payouts for at least two negatively correlated perils;
(b) specifying at least one of said statistical properties based upon its relation to an acceptable risk level;
(c) creating at least one insurance policy contract between at least one insurer and at least one insured that meets the at least one statistical property and insures against both of said at least two negatively correlated perils by obligating said at least one insurer to pay out benefits to said at least one insured in the event that any of said at least two perils occurs;
(d) fixing the benefit levels for the life of the policy at the time the policy is issued; and
(e) paying, by the insurer, benefits to the insured after any of said at least two perils occurs.

6. A method for forming a multi-peril insurance policy with pre-specified statistical properties for a selected population of potential policyholders, the members of which are treated as substantially homogeneous, and the probability distributions of which are estimated for payments of benefits to policyholders, the method comprising:
(a) estimating a plurality of statistical properties of benefit payouts for at least three perils, at least two of which are negatively correlated;
(b) specifying at least one of said statistical properties based upon its relation to an acceptable risk level;
(c) creating at least one insurance policy contract between at least one insurer and at least one insured that meets the specified statistical property and insures against both of said at least two negatively correlated perils by obligating said at least one insurer to pay out benefits to said at least one insured in the event that any of said at least three perils occurs; and
(d) paying, by the insurer, benefits to the insured after any of said at least three perils occurs.

7. The method in accordance with claim 6, further comprising fixing the benefit levels for the life of the policy at the time the policy is issued.
